(19) United States
(12) Patent Application Publication
(10) Pub. No.: US 2020/0257396 A1
(43) Pub. Date: Aug. 13, 2020

(54) ELECTRONIC DEVICE AND CONTROL METHOD THEREFOR

(71) Applicant: CANON KABUSHIKI KAISHA, Tokyo (JP)

(72) Inventors: Junko Tajima, Kawasaki-shi (JP); Nari Miyoshi, Tokyo (JP)

(21) Appl. No.: 16/860,931

(22) Filed: Apr. 28, 2020

Related U.S. Application Data
(63) Continuation of application No. PCT/JP2018/041811, filed on Nov. 12, 2018.

(30) Foreign Application Priority Data
Nov. 21, 2017 (JP) 2017-223649
Nov. 2, 2018 (JP) 2018-207347

(51) Int. Cl. G06F 3/041; H04N 5/232

(52) U.S. Cl. CPC G06F 3/0412; G06F 3/0416; H04N 5/23293

(57) ABSTRACT

An electronic device according to the present invention can display a plurality of images in a display region, and can detect a change in the orientation of a display means. For each image displayed in the display region among the plurality of images, a displayed display range in the image is changed. When a first display target image and a second display target image are displayed in the display region, a display range of the first display target image is changed in accordance with the change in the orientation of the display means, and a display range of the second display target image is changed in accordance with the change in the orientation of the display means if a predetermined condition is met, but the display range of the second display target image is not changed if the predetermined condition is not met.

### CROSS-REFERENCE TO RELATED APPLICATIONS

This application is a Continuation of International Patent Application No. PCT/JP2018/041811, filed Nov. 12, 2018, which claims the benefit of Japanese Patent Application No. 2017-223649, filed Nov. 21, 2017 and No. 2018-207347, filed Nov. 2, 2018, all of which are hereby incorporated by reference herein in their entirety.

### TECHNICAL FIELD

The present invention relates to an electronic device that can change a display portion of an image and a control method therefor.

### BACKGROUND ART

Hitherto, there is a method for changing a display range of an image in accordance with the orientation of a device. Japanese Patent Laid-Open No. 2012-75018 discloses that when a digital camera rotates and moves in a panorama playback mode, the range of a portion of a panorama image in the direction in which the digital camera faces is displayed. In addition, there is a method for switching an image displayed on a display screen. Japanese Patent Laid-Open No. 2014-222829 discloses that a plurality of images are aligned vertically in a display region and the image displayed in the display region can be switched by scrolling.

In Japanese Patent Laid-Open No. 2012-75018, when display of an image is started, a range of an image corresponding to the orientation of the digital camera at that moment is displayed, and thus, for example, the image cannot be checked from a reference range or a range desired by the user, and the user needs to change the display range by changing the orientation of the digital camera. In Japanese Patent Laid-Open No. 2014-222829, when display of an image is started, in a case where the user wants to display the range of a portion of the image in an enlarged manner, the user needs to perform an enlargement operation.

### CITATION LIST

### Patent Literature

PTL 1: Japanese Patent Laid-Open No. 2012-75018

PTL 2: Japanese Patent Laid-Open No. 2014-222829

### SUMMARY OF INVENTION

The present invention has been made in light of the above-described problems, and an object of the present invention is to increase ease of operation for displaying the range of a portion of an image in a case where a plurality of images can be arranged and displayed in a display region.

In order to achieve the above-described objectives, an electronic device according to the present invention includes a detection means capable of detecting a change in an orientation of a display means, a switching means that switches an image displayed on a display surface among a plurality of images, a change means that changes a portion of an image displayed on the display surface, a recording means that records information regarding a portion of an image displayed on the display surface in a case where switching is performed by the switching means among the plurality of images, and a control means that performs control such that, in a case where a portion of a first image among the plurality of images is displayed on the display surface, the change means changes, in accordance with detection of the change in the orientation of the display means by the detection means, a displayed portion by an amount corresponding to the change in the orientation, the information on a second image is changed in accordance with the change in the orientation in a case where the second image meets a predetermined condition when a displayed image is switched from the first image to the second image, and the information on the second image is not changed in a case where the second image does not meet the predetermined condition.

Further features of the present invention will become apparent from the following description of exemplary embodiments with reference to the attached drawings.

### BRIEF DESCRIPTION OF DRAWINGS

FIG. 1A is an external view of a smartphone as an example of a device to which the configuration of a present embodiment is applicable.

FIG. 1B is a block diagram illustrating an example of the configuration of the smartphone as an example of the device to which the configuration of the present embodiment is applicable.

FIG. 2A is a diagram illustrating an example of display of a screen according to the present embodiment.

FIG. 2B is a diagram illustrating an example of display of a screen according to the present embodiment.

FIG. 2C is a diagram illustrating an example of display of a screen according to the present embodiment.

FIG. 3 is a flow chart illustrating display processing according to the present embodiment.

FIG. 4 is a flow chart illustrating active image determination processing according to the present embodiment.

FIG. 5 is a flow chart illustrating display range change processing according to the present embodiment.

FIG. 6 is a flow chart illustrating update processing according to the present embodiment.

FIG. 7A is a diagram illustrating an example of image display according to the present embodiment.

FIG. 7B is a diagram illustrating an example of image display according to the present embodiment.

FIG. 7C is a diagram illustrating an example of image display according to the present embodiment.

FIG. 7D is a diagram illustrating an example of image display according to the present embodiment.

FIG. 7E is a diagram illustrating an example of image display according to the present embodiment.

FIG. 7F is a diagram illustrating an example of image display according to the present embodiment.

FIG. 7G is a diagram illustrating an example of image display according to the present embodiment.

FIG. 7H is a diagram illustrating an example of image display according to the present embodiment.

FIG. 8A is a diagram for describing image display according to the present embodiment.

FIG. 8B is a diagram for describing image display according to the present embodiment.

FIG. 8C is a diagram for describing image display according to the present embodiment.

FIG. 8D is a diagram for describing image display according to the present embodiment.

### DESCRIPTION OF EMBODIMENTS

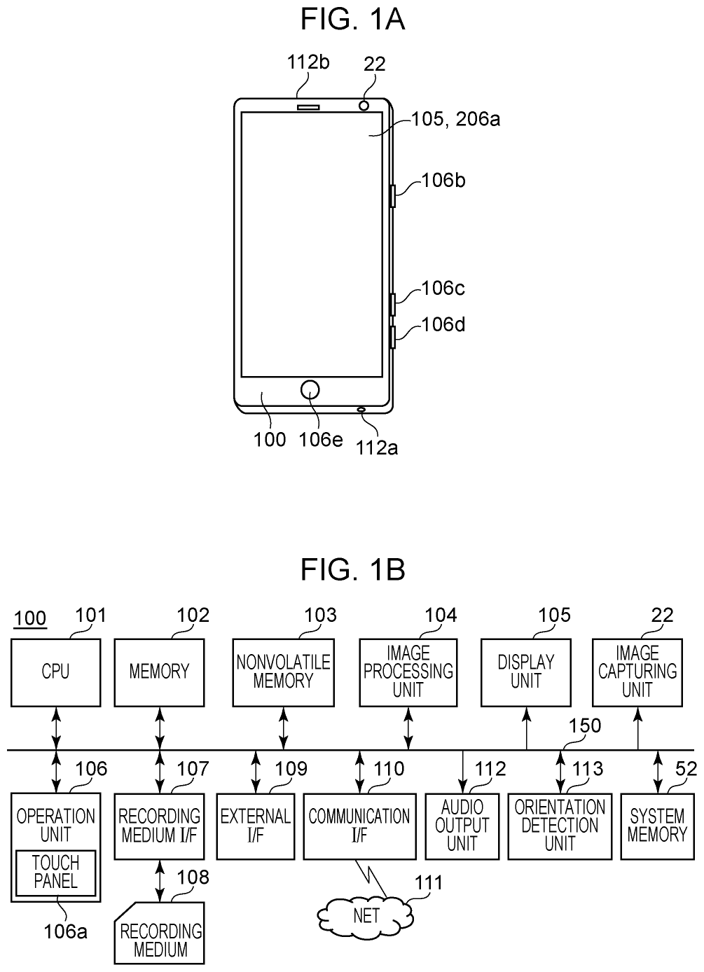

In the following, preferred embodiments of the present invention will be described with reference to the drawings. FIGS. 1A and 1B illustrate the configuration of a smartphone 100 as an example of an electronic device in a present embodiment. FIG. 1A illustrates an example of an external view of the smartphone 100. A display unit 105 is a display unit that displays images and various types of information. The display unit 105 is integrally formed with a touch panel 106a, and is configured to be capable of detecting a touch operation performed on the display surface of the display unit 105. An operation unit 106 includes operation units 106b, 106c, 106d, and 106e as illustrated in the drawing. The operation unit 106b is a power button, which accepts an operation for switching between ON and OFF of the power source of the smartphone 100. The operation unit 106c and the operation unit 106d are volume buttons for increasing and decreasing the volume of voice and sound output from an audio output unit 112. The operation unit 106e is a home button for causing the display unit 105 to display a home screen. The audio output unit 112 includes an audio output terminal 112a to which, for example, earphones are connected, and a speaker 112b for outputting the voice and sound of a call. In addition, an image capturing unit 22 is provided on a surface on the opposite side of the display unit 105 and on a surface on the side where the display unit 105 is provided.

In FIG. 1B, a central processing unit (CPU) 101, a memory 102, a nonvolatile memory 103, an image processing unit 104, the display unit 105, the image capturing unit 22, the operation unit 106, a storage medium interface (I/F) 107, an external I/F 109, and a communication I/F 110 are connected to an internal bus 150. In addition, the audio output unit 112, an orientation detection unit 113, and a system memory 52 are also connected to the internal bus 150. The individual units connected to the internal bus 150 are configured to be capable of transmitting and receiving data to and from each other via the internal bus 150.

The CPU 101 is a controller that controls the entirety of the smartphone 100, and is constituted by at least one processor. The memory 102 is constituted by, for example, a random access memory (RAM), which is for example a volatile memory using a semiconductor device. The memory 102 stores image data, which is digital data converted from data obtained by the image capturing unit 22, and image data to be displayed on the display unit 105. The memory 102 has a storage capacity sufficient for storing a predetermined number of still images and a predetermined time period of a moving image and voice and sound. In addition, the memory 102 also serves as a memory for image display (a video memory). A RAM is used as the system memory 52. For example, constants and variables for the operation of the CPU 101, and a program read out from the nonvolatile memory 103 are loaded into the system memory 52.

The CPU 101 controls, using the memory 102 as a work memory, the individual units of the smartphone 100 in accordance with, for example, a program stored in the nonvolatile memory 103. Image data, audio data, other data, and various programs for the operation of the CPU 101 are stored in the nonvolatile memory 103. The nonvolatile memory 103 is constituted by, for example, a flash memory or a read-only memory (ROM).

On the basis of control performed by the CPU 101, the image processing unit 104 performs various types of image processing on, for example, images stored in the nonvolatile memory 103 and a storage medium 108, a video signal acquired via the external I/F 109, and images acquired via the communication I/F 110. Image processing performed by the image processing unit 104 includes, for example, analog to digital (A/D) conversion processing, digital to analog (D/A) conversion processing, image data encoding processing, compression processing, decoding processing, enlargement/reduction processing (resizing), noise reduction processing, and color conversion processing. In addition, the image processing unit 104 also performs various types of image processing such as panorama development, mapping processing, and conversion on an omnidirectional image or a wide range image having data of a wide but not omnidirectional range. The image processing unit 104 may be constituted by a dedicated circuit block for performing specific image processing. In addition, depending on the type of image processing, it is also possible that the CPU 101 performs image processing in accordance with a program without using the image processing unit 104.

On the basis of control performed by the CPU 101, the display unit 105 displays, for example, images and a graphical user interface (GUI) screen constituting a GUI. The CPU 101 generates a display control signal in accordance with a program, and controls various units of the smartphone 100 so as to generate a video signal to be displayed on the display unit 105 and to output the video signal to the display unit 105. The display unit 105 displays images based on the output video signal.

Note that the smartphone 100 itself is configured to include an interface for outputting a video signal to be displayed on the display unit 105, and the display unit 105 may be configured as an external monitor (such as a television).

The operation unit 106 is an input device for accepting an operation by a user, and examples of the operation unit 106 include a character information input device such as a keyboard, pointing devices such as a mouse and a touch panel, and buttons, a dial, a joystick, a touch sensor, and a touch pad. Note that the touch panel is an input device that overlies the display unit 105 in a planar manner and that is configured to output coordinate information corresponding to a touched position.

The storage medium 108 such as a memory card, a compact disc (CD), or a digital versatile disc (DVD) is removable from the storage medium I/F 107. On the basis of control performed by the CPU 101, the storage medium I/F 107 reads out data from the storage medium 108 attached thereto and writes data into the storage medium 108.

The external I/F 109 is connected to an external device by a cable or wirelessly, and is an interface for inputting-outputting a video signal and an audio signal.

The communication I/F 110 is an interface for communicating with, for example, an external device and the Internet 111 and for transmitting and receiving various types of data such as files and commands.

The audio output unit 112 outputs voice and sound from a moving image or music data, operation sound, a ring tone, and various types of notification sound. The audio output unit 112 may perform audio output through, for example, wireless communication.

The orientation detection unit 113 detects the orientation of the smartphone 100 (the display unit 105) with respect to the direction of gravity. On the basis of the orientation detected by the orientation detection unit 113, it can be determined, for example, whether the smartphone 100 is horizontally held, is vertically held, faces upward, faces downward, or is tilted. As the orientation detection unit 113, at least one of sensors such as an acceleration sensor, a gyro sensor, a geomagnetic sensor, and an azimuth sensor can be used, and it is also possible to combine and use a plurality of sensors.

Note that the operation unit 106 includes the touch panel 106a. The CPU 101 can detect the following operations performed on or the following states of the touch panel 106a.

The touch panel 106a is newly touched by a user's finger or pen that has not touched the touch panel 106a, that is, touching is started (hereinafter referred to as Touch-Down).

A state in which the touch panel 106a is touched by his or her finger or pen (hereinafter referred to as Touch-On).

His or her finger or pen is moving while touching the touch panel 106a (hereinafter referred to as Touch-Move).

His or her finger or pen touching the touch panel 106a is moved away from the touch panel 106a, that is, touching is ended (hereinafter referred to as Touch-Up).

A state in which nothing is touching the touch panel 106a (hereinafter referred to as Touch-Off).

When Touch-Down is detected, Touch-On is simultaneously detected, too. Unless Touch-Up is detected after detection of Touch-Down, Touch-On is usually continuously detected.

Also in a case where Touch-Move is detected, Touch-On is simultaneously detected. Even when Touch-On is detected, if the touch position is not being moved, Touch-Move is not detected.

When Touch-Up is detected for all the fingers or pens that have been touching, Touch-Off is detected.

These operations and states and the coordinates of the position where his or her finger or pen is touching on the touch panel 106a are reported to the CPU 101 via the internal bus, and the CPU 101 performs a determination as to what operation (touch operation) has been performed on the touch panel 106a on the basis of the reported information.

Regarding Touch-Move, the movement direction of his or her finger or pen moving on the touch panel 106a can also be determined on the basis of changes in position coordinates on a vertical component basis and on a horizontal component basis on the touch panel 106a. In a case where Touch-Move is detected over at least a predetermined distance, it is determined that a slide operation has been performed.

An operation in which the user's finger is quickly moved some distance on the touch panel 106a while touching the touch panel 106a and then is simply moved away from the touch panel 106a is called a flick. In other words, a flick is an operation for moving the user's finger quickly along the surface of the touch panel 106a such that the touch panel 106a is stricken lightly with his or her finger. When it is detected that Touch-Move has been performed for at least a predetermined distance at a predetermined speed or faster and then Touch-Up is detected, it can be determined that a flick has been performed. (It can be determined that, subsequent to performance of a slide operation, a flick has been performed).

Furthermore, when a plurality of positions (for example, two positions) are touched simultaneously, an operation for bringing the touch positions close to each other is called Pinch-In and an operation for locating the touch positions away from each other is called Pinch-Out. Pinch-Out and Pinch-In are collectively called pinch operations (or simply Pinch).

As the touch panel 106a, any touch panel may be used among touch panels using various methods such as a resistive film method, a capacitive sensing method, a surface acoustic wave method, an infrared method, an electromagnetic induction method, an image recognition method, and an optical sensing method.

There are a method in which touching is detected when something is in contact with a touch panel and a method in which touching is detected when a user's finger or pen is in close vicinity to a touch panel, and either method may be used.

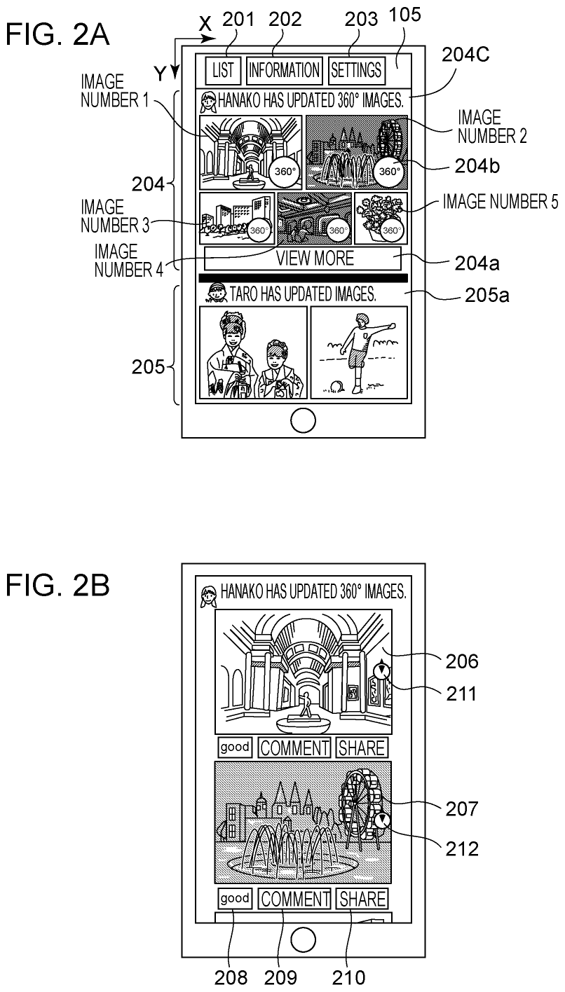

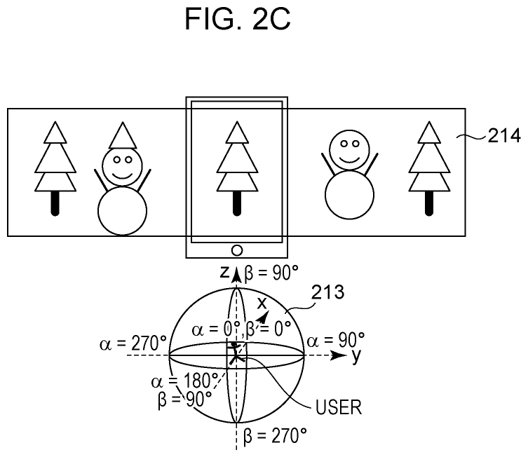

FIGS. 2A to 2C illustrate examples of display of a screen according to the present embodiment. FIGS. 2A and 2B illustrate examples of display of a social network service (SNS) screen. FIG. 2A illustrates a state of a list screen in which a list item 201 is selected from among the list item 201, an information item 202, and a setting item 203. When the list item 201 is selected, the user can check, for example, images updated by and comments from individual users, and the user can scroll (move) displayed images and comments in accordance with Touch-Move by performing Touch-Move along the Y-axis direction of the display unit 105. When a user updates an image and a comment, the summary of the updated information, for example, posts 204 and 205 displaying a portion of the updated image and comment is displayed on the list screen. For example, when Touch-Move is performed in the negative Y-axis direction, the posts 204 and 205 move in the negative Y-axis direction. When the information item 202 is touched, information for the user is displayed, and when the setting item 203 is touched, user settings and various settings for, for example, login information can be set. The post 204 is a post indicating that Hanako has updated 360° images, as illustrated in guidance 204c. An item 204b displayed in the image indicates that the displayed image is a 360° image. When an item 204a is touched, the details of the post 204, that is, a list of images updated as the post 204 can be displayed. The post 205 indicates that Taro has updated images, as illustrated in guidance 205a.

FIG. 2B illustrates a state in which the item 204a is touched in FIG. 2A and the details of the post 204 are displayed. For the details of the post, the region of a portion of each image included in the post 204 is displayed so as to have a width matching the width of a display region in the X-axis direction, and a plurality of images are aligned and displayed in the Y-axis direction. In the example of display in FIG. 2B, the regions of portions of images 206 and 207 are aligned and displayed in the Y-axis direction. Items 211 and 212 are items indicating that what range of the 360° image is displayed, and the items 211 and 212 indicate that the range in a reference direction is displayed. At a position under each image, items 208 to 210 corresponding to the image are displayed. The item 208 is an item (good) for positively evaluating the image. By touching the item 208, the user who has updated the image can be notified that the image has been positively evaluated. The item 209 is an item for making a comment such as an impression or an opinion on the updated image. By touching the item 209, a keyboard for making a comment is displayed. The item 210 is an item for sharing the updated image. By touching the item 210, the image can be transmitted through another SNS or by email. Note that image acquisition, making a notification of good, making a comment, and sharing are performed via the Internet.

FIG. 2C is a diagram for describing that the region of a portion of the entirety of a 360° image is displayed on the display unit 105. A 360° image is an image having a 360° field of view, and the display unit 105 can display the region of a portion of the image. An image 214 is an image simply illustrating a 360° image, and the user can switch a region displayed on the display unit 105 in accordance with a detection result from the orientation detection unit 113. Switching of a displayed region in accordance with the orientation of the display unit 105 as if the user were actually at the place as illustrated by a circle 213 is called virtual reality (VR) display. In the following, a VR image and VR display will be described in detail. Note that a case where a VR image has a 360° field of view will be described in the present embodiment; however, the present invention can be similarly realized even in a case where a VR image has, for example, a 180° field of view or a 270° field of view.

First, a VR image is an image that can be displayed in VR. VR images include, for example, an omnidirectional image (a 360° image) captured by an omnidirectional camera (a 360° camera) and a panorama image having a wider image range (an effective image range) than a display range that can be displayed at once on a display means. In addition, VR images (VR content) include not only images captured by cameras but also images that are generated using computer graphics (CG) and that can be displayed in VR. VR images also include not only still images but also moving images and live view images (an image output to a display unit by acquiring, in almost real time, an image signal continuously read out from an image pick up element of a camera). A VR image has an image range (an effective image range) having a field of view with a maximum of 360 degrees in the up-down direction (a vertical angle, an angle from the zenith, an elevation angle, a depression angle, an altitude angle), and a maximum of 360 degrees in the left-right direction (a horizontal angle, an azimuth angle). In addition, VR images include an image having a wider angle of view (a field of view) than the angle of view that can be captured by a normal camera or a wider image range (an effective image range) than a display range that can be displayed at once on a display means even in a case where the image has a range of less than 360 degrees in the up-down direction and a range of less than 360 degrees in the left-right direction. For example, an image captured by an omnidirectional camera capable of capturing an image of a subject covering a field of view (an angle of view) having (a horizontal angle of, an azimuth angle of) 360 degrees in the left-right direction and a vertical angle of 210 degrees when the zenith is the center is a type of VR image. That is, an image having an image range with a field of view of 180 degrees (±90 degrees) or more in each of the up-down direction and the left-right direction, and having a wider image range than the range that a person can view at once is a type of VR image. When this VR image is displayed in VR, a seamless omnidirectional image can be viewed in the left-right direction (the horizontal rotation direction) by changing the orientation in the left-right rotation direction. When viewed from the point directly above the user (the zenith), a seamless omnidirectional image can be viewed in a range of ±105 degrees in the up-down direction (the vertical rotation direction); however, the range beyond 105 degrees from the point directly above the user is a blank region where no image is present. A VR image can also be called “an image the image range of which is at least a portion of virtual space (VR space)”.

VR display is a display method with which a display range of a VR image can be changed, the display range displaying an image having a field of view corresponding to the orientation of the smartphone 100 detected by the orientation detection unit 113. In a case where the user views an image using the smartphone 100 set in VR goggles, an image having a field of view corresponding to the orientation of the user's face is displayed. For example, in a VR image, an image having a viewing angle (an angle of view) in which the position located at 0 degrees in the left-right direction (a specific azimuth, for example, the north) and at 90 degrees in the up-down direction (90 degrees from the zenith, that is, horizontal) is treated as the center is displayed at a certain point in time. When, from this state, the orientation of the smartphone is changed such that the smartphone is facing in the opposite direction (for example, the display surface is changed to face the north from the south), the display range is changed, in the same VR image, to an image having a viewing angle in which the position located at 180 degrees in the left-right direction (the opposite azimuth, for example, the south) and at 90 degrees in the up-down direction (horizontal) is treated as the center. In the case where the user views an image using the smartphone 100 set in the VR goggles, when the user turns his or her face so as to face the south from the north (that is, when the user turns around), the image displayed on the smartphone 100 is changed from an image for the north to an image for the south. By performing such VR display, it is possible to visually cause the user to have a feeling as if he or she were actually at the place in the VR image (in the VR space).

As described above, since a portion of an image is displayed in VR display, a display angle α indicating a display range on the display unit 105 will be described. As illustrated in the circle 213 in the lower portion of FIG. 2C, an angle of the circle on the XY axis plane is denoted by α, and an angle of the circle on the XZ axis plane is denoted by β. In the following embodiment, recording is performed for each angle image on the XY axis plane, and the angle β of the circle on the XZ axis plane=0 is recorded; however, the angle β can also be changed by moving the smartphone in the Z-axis direction as described above.

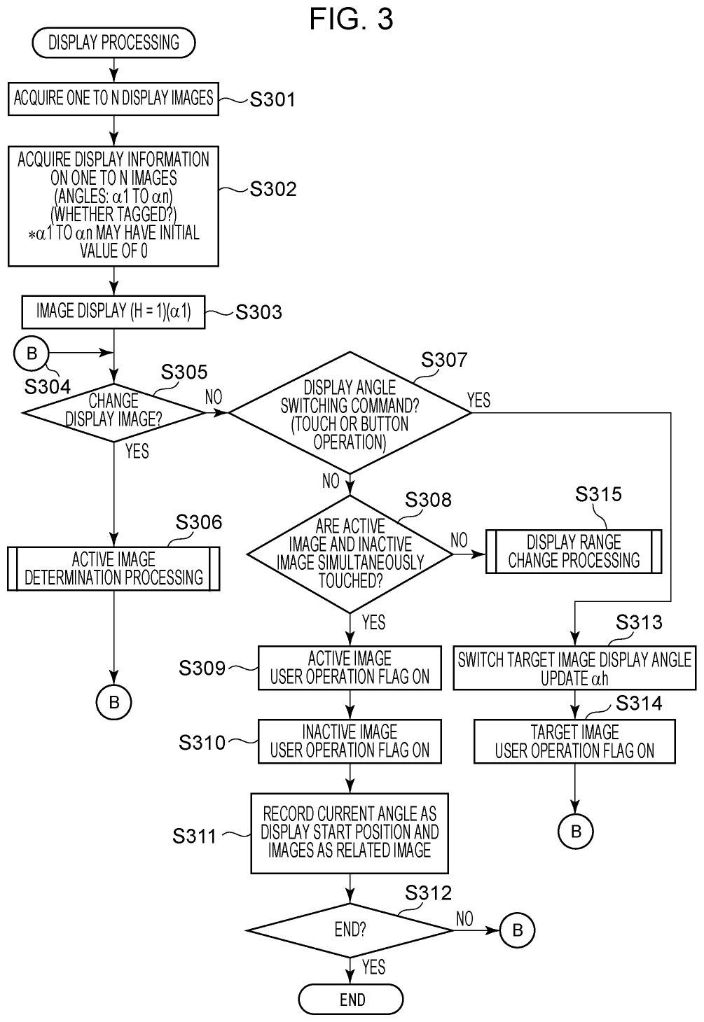

Display processing according to the present embodiment will be described using FIG. 3. This processing is realized by loading a program recorded in the nonvolatile memory 103 into the system memory 52 and executing the program using the CPU 101. Note that this processing is started when a plurality of 360° images can be displayed after the smartphone 100 is switched on.

In S301, the CPU 101 acquires a plurality of images to be displayed, that is, images having image numbers 1 to N via the communication I/F 110. The image numbers indicate the order in which a plurality of images included in one post are displayed. That is, in S301, image data is acquired such that each of the plurality of images to be displayed from now on can be displayed in VR. In S301, the image data acquired via the communication I/F 110 is loaded into the system memory 52.

In S302, the CPU 101 acquires, via the communication I/F 110, display angles α1 to αN indicating display start positions of the images having image numbers 1 to N and display information indicating, for example, whether the images are tagged. For each image, a tag indicates whether the user has determined in advance a display range displayed when display of the image is started. That is, in a case where the user has set a display range in order to start displaying a 360° image from a portion of the 360° image where, for example, a main subject or a subject of interest is seen, the image is tagged. For an image that is not tagged, display is started with a display range the center of which is the display angle αn=0, that is, a reference position. For an image that is tagged, display is started with a display range the center of which is a position specified by the user such as αn=30° or 60°. Also in S302, the display information regarding the image acquired via the communication I/F 110 is loaded into the system memory 52.

In S303, the CPU 101 displays, on the display unit 105, a display range the center of which is at the display angle α1 of the image having image number 1. The displayed image is treated as a display image H, and the display image H=an image number. In a case where the display angle α1 is set to the center, the range displayed on the display unit 105 is changed in accordance with a display magnification and the angle β of the display unit 105 (display means). For example, at α1, the display range in a case of β=30° differs from that in a case of β=210° such that the display range displays an area above the camera at the time of image capturing in the former case and an area below the camera in the latter case.

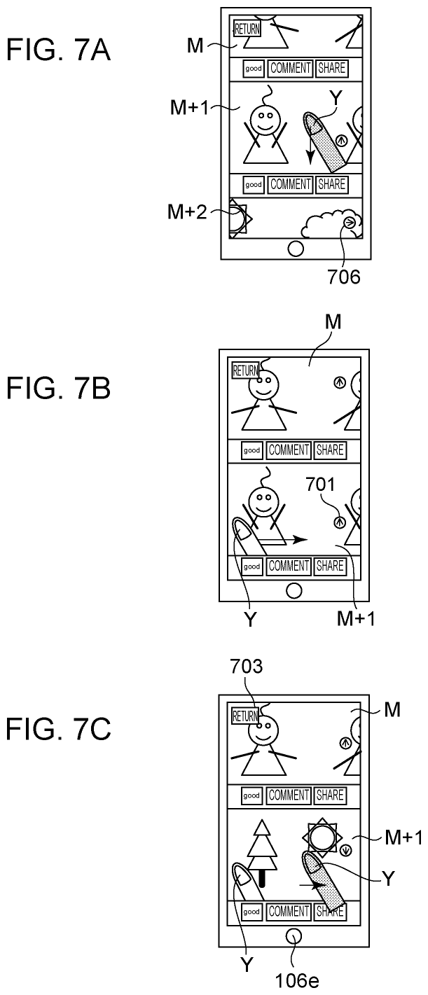

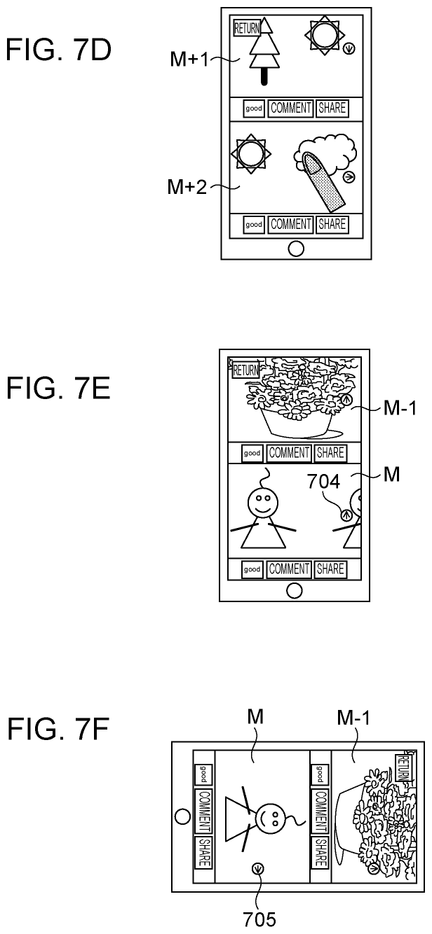

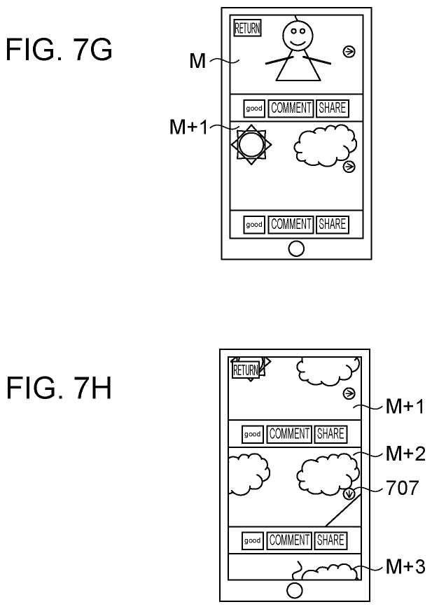

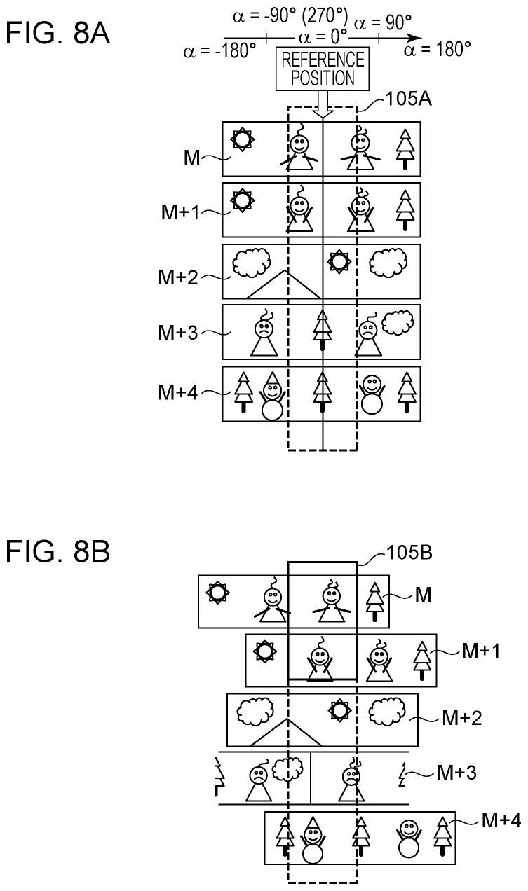

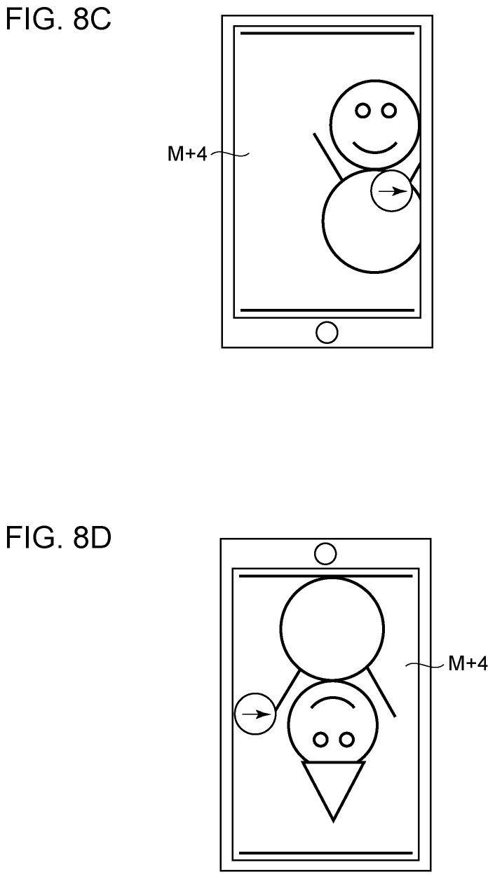

In S305, the CPU 101 determines whether to change the display image. In a case where it is determined that the display image is to be changed, the process proceeds to S306. Otherwise, the process proceeds to S307. The display image can be performed by performing a scroll operation (issuing a scroll command) on a touch panel 206a, that is, a display surface of the display unit 105. When scrolling is performed upward on the display unit 105, images having larger image numbers are displayed, and when scrolling is performed downward, images having smaller image numbers are displayed. FIGS. 7A to 7H illustrate examples of display of images in the present embodiment. In FIG. 7A, image numbers M to M+2 are displayed. When the user performs Touch-Move downward with his or her finger Y, the portion of the image number M displayed on the display unit 105 is increased and the image having image number M+2 and displayed in FIG. 7A is not displayed as illustrated in FIG. 7B. In this manner, images displayed on the display unit 105 and the size of a region where each image is displayed can be changed by vertically performing a scroll operation. FIGS. 8A and 8B are diagrams for describing display of a 360° image included in one post in the present embodiment. In FIGS. 8A and 8B, images having image numbers M to M+4 in the 360° image included in the one post are aligned and illustrated. A frame 105A of FIG. 8A is a frame used to describe a range that can be displayed on the display unit 105, and an image range (displayed in the frame 105A) that the user can observe can be changed by changing the display range of each 360° image. A frame 105B of FIG. 8B is a frame indicating a region including a Y-axis direction range of the display unit 105. When the user changes the display image by performing, for example, the scroll operation in S305, the display image or display region in the frame 105B is changed in the Y-axis direction.

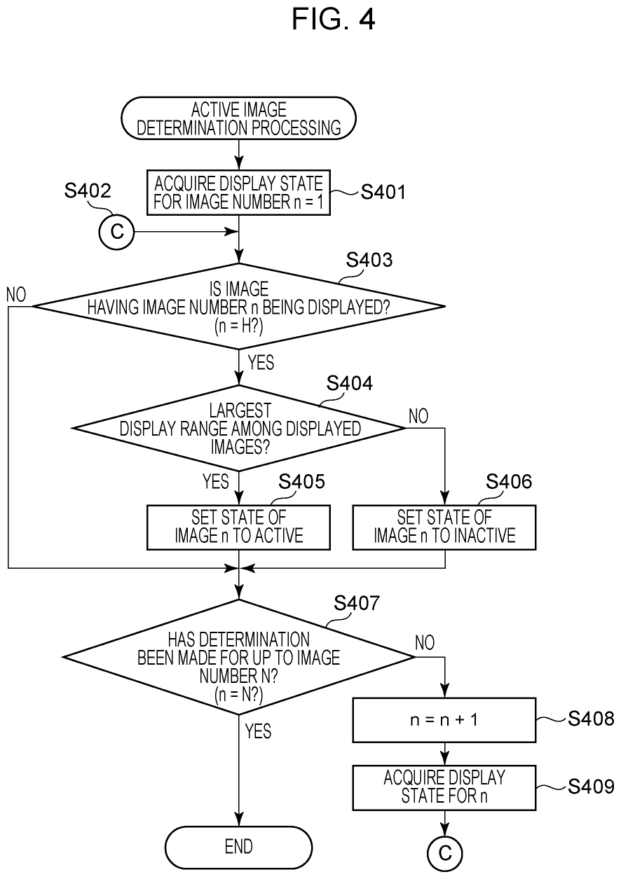

In S306, the CPU 101 performs active image determination processing. The active image determination processing will be described later using FIG. 4. In S307, the CPU 101 determines whether a display angle (display range) switching command has been issued by a touch operation or a button operation performed by the user. The display angle switching command corresponds to an operation for switching the display range (the center of the display range) of a currently displayed 360° image on the display unit 105. When Touch-Move is performed horizontally with his or her finger Y as illustrated in FIG. 7B, the display range is switched and a different range of the image having image number M+1 can be displayed as illustrated in FIG. 7C. In FIGS. 7B and 7C, the display angle for the image number M+1 is changed from α(M+1)=0° to α(M+1)=180°. Items 701 and 702 are items for indicating the display angle and the display angle displayed together with each image, and the item 701 indicates α(M+1)=0° and the item 702 indicates α(M+1)=180°. In S307, in a case where it is determined that the display angle switching command has been issued, the process proceeds to S313. Otherwise, the process proceeds to S308. In S308, the CPU 101 determines whether an active image and an inactive image are simultaneously touched. Both of the active image and the inactive image are images displayed on the display unit 105. The active image is the image having the largest display region on the display unit 105, and the inactive image is an image having a smaller display region than the active image. The active image will be described later using FIG. 4. In FIG. 7C, among the images having image numbers M and M+1 and displayed on the display unit 105, the image having image number M+1 is displayed larger, and thus the image having image number M+1 is the active image. In a case where it is determined that the active image and the inactive image are simultaneously touched, the process proceeds to S309. Otherwise, the process proceeds to S315.

In S309, the CPU 101 sets a user operation flag of the active image to ON, and records that in the system memory 52. The user operation flag is a flag for preventing the display angle of the current image from being unintentionally changed, and when the user operation flag is set to ON, even in a case where the display angles of other images other than its related images are changed in accordance with a change in the orientation of the display unit 105, the display angle thereof is not changed. That is, in a case where another image other than its related images is an active image, even in a case where the orientation of the display unit 105 is changed, the display angle of the image for which the user operation flag is ON is not changed.

In S310, the CPU 101 sets a user operation flag of the inactive image to ON, and records that in the system memory 52.

In S311, the CPU 101 records, in the system memory 52, the display angle α of the current active image as a display start position and the active image and the inactive image that are simultaneously touched as related images.

In S312, the CPU 101 determines whether to end the display processing. The display processing ends when a touch operation is performed on a return item such as an item 703 illustrated in FIG. 7C, when the operation unit 106e (home button) is pressed, or when the power of the smartphone 100 is switched off. In a case where it is determined that the display processing is to end, the display processing is ended. Otherwise, the process returns to S304 and further to S305. When the touch operation is performed on the item 703, the display returns to the list screen as illustrated in FIG. 2A. When the display processing ends, the user operation flags of all the images included in the displayed post are set to OFF. In S313, the CPU 101 switches the display angle of the image (target image) for which the switching command has been issued in S307. As described using FIGS. 7B and 7C in S307, in S313, the display angle is switched for only the image for which the switching command has been issued.

In S314, the CPU 101 sets the user operation flag of the image (target image) for which the switching command has been issued in S307 to ON, and the process proceeds to S304 and then to S305.

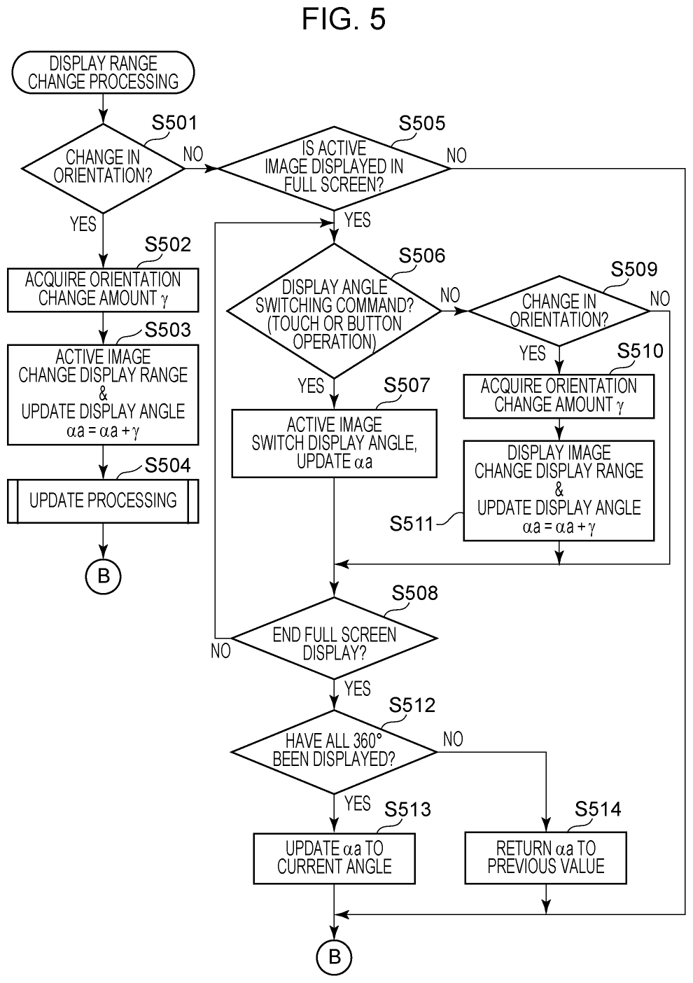

In S315, the CPU 101 performs display range change processing. The display range change processing is processing in which the display angle α of an active image is changed in accordance with the orientation of the display unit 105, and will be described later also using FIG. 5.

Next, using FIG. 4, active image determination processing will be performed. This processing is started when the process proceeds to S306 of FIG. 3.

In S401, the CPU 101 acquires a display state of the image having image number 1. The display state of an image indicates whether the image is displayed and how large is the region of the displayed image in the display region of the display unit 105. In FIG. 4, in order from image number 1 to N, a determination as to whether the image is an active image is performed. The image subjected to the determination is expressed by image number n.

In S403, the CPU 101 determines whether the image having image number n is currently being displayed. In a case where it is determined that the image number n is being displayed, the process proceeds to S404. Otherwise, the process proceeds to S407.

In S404, the CPU 101 determines whether, among the images displayed on the display unit 105, the area of a region where the image having image number n is displayed is larger than the areas of regions where the other display images are individually displayed. In a case where it is determined that the region where the image having image number n is displayed is the largest, the process proceeds to S405. Otherwise, the process proceeds to S406.

In S405, the CPU 101 sets the state of the image having image number n to active.

In S406, the CPU 101 sets the state of the image having image number n to inactive.

In S407, the CPU 101 determines whether the determination in S403 has been made for the images having image numbers up to N. That is, it is determined whether all the images included in the post have been determined to be any one of an active image, an inactive image, and an undisplayed image. In a case where the image having image number n corresponds to image number N and it is determined that the above-described determination has been completed, the active image determination processing ends. Otherwise, the process proceeds to S408.

In S408, the CPU 101 obtains image number n=n+1. That is, the determination in and after S403 is performed for the next image number.

In S409, the CPU 101 acquires the display state for image number n similarly to as in S401, and the process proceeds to S402 and then to S403.

Note that in the processing of FIG. 4, the active image may be detected by detecting the image having the largest display area among the displayed images.

Alternatively, in step S404, it may be determined which one of display target images is the closest to a predetermined position of the display region (for example, the upper left or the center), and the closest image may be determined to be the active image in step S405.

Alternatively, in step S404, it may be determined whether an image is selected, and in a case where an image is selected, the image may be determined to be the active image in step S405.

Next, display range change processing according to the present embodiment will be described using FIG. 5. The display range change processing is processing in which the display angle α of an active image is changed in accordance with the orientation of the display unit 105 (the smartphone 100), and is started when the process proceeds to S315 of FIG. 3.

In S501, the CPU 101 determines whether there is a change in the orientation of the smartphone 100 by using the orientation of the smartphone 100 detected by the orientation detection unit 113. In a case where it is determined that there is a change in the orientation of the smartphone 100, the process proceeds to S502. Otherwise, the process proceeds to S505. In S502, the CPU 101 acquires an orientation change amount γ.

In S503, the CPU 101 changes the display range of the active image, and records the display angle of the active image as αa=αa+γ in the system memory 52. In FIG. 7E, in a case where the image number of the active image is M, when the orientation of the smartphone 100 is changed by 90° clockwise on the XY plane, the display range of the image is changed as illustrated in FIG. 7F. In this case, the state in which αa=0° before the orientation is changed is changed to αa=90°. In addition, display of an item indicating the display angle is changed with a change in the orientation of the smartphone 100. An item 704 indicating the display angle and illustrated in FIG. 7E indicates that the display angle is 0 degrees; however, after the orientation is changed, an item 705 illustrated in FIG. 7F indicates that the display angle is 90 degrees. In this manner, since the item indicating the display angle is changed to indicate a different display angle as the orientation of the smartphone 100 is changed, the user can easily recognize roughly which portion of a 360° image the user is viewing. Note that the way in which the item indicating the display angle is displayed is changed also in a case where the user changes the display range by, for example, performing a touch operation in S307 or S313. The frame 105A illustrated in FIG. 8A has been described as a thing that indicates a range that can be displayed on the display unit 105; however, when the orientation of the smartphone 100 is changed or when the display range is changed by performing, for example, a touch operation, the display range is changed as illustrated in FIG. 8B. That is, the display angles displayed in the frame 105B are changed to the display angles as illustrated in FIG. 8B from the state in which α=0 for all the images in FIG. 8A. In FIG. 8B, when the display image is switched to an image having a larger image number as in S305, the range determined by the frame 105B moving downward is displayed on the display unit 105.

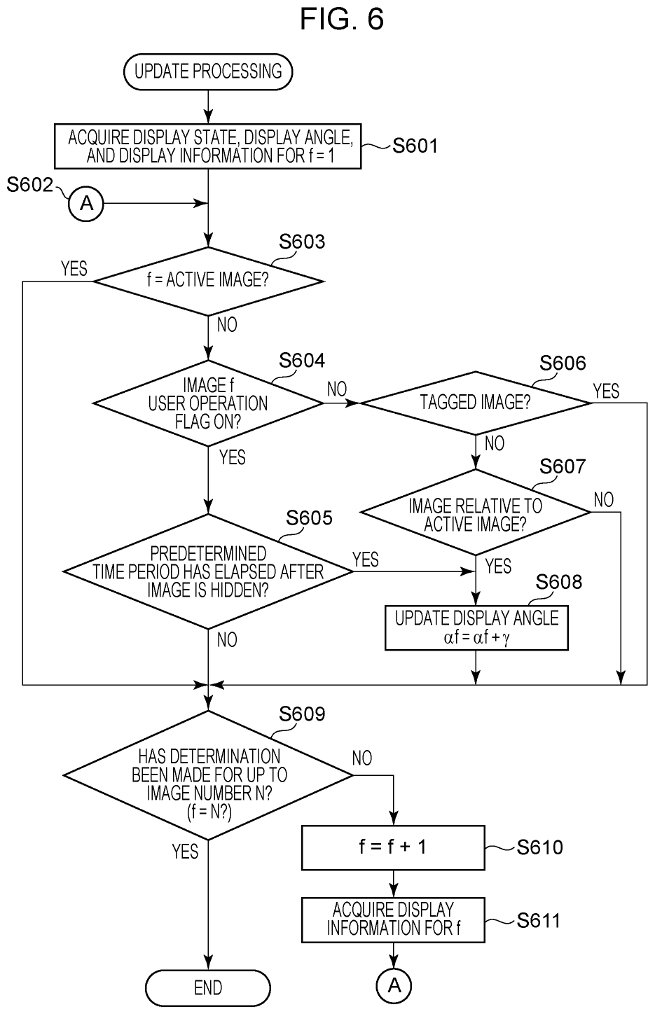

In S504, the CPU 101 performs update processing. The update processing is processing for updating the display angles of other images on the basis of a change in the display range of the active image due to a change in the orientation of the smartphone 100. The update processing will be described later using FIG. 6.

In S505, the CPU 101 determines whether the active image is displayed in full screen in the display region of the display unit 105. In a case where it is determined that the active image is displayed in full screen on the display unit 105, the process proceeds to S506. Otherwise, the process proceeds to S304 of FIG. 3. FIGS. 8C and 8D illustrate examples of display in cases where an image having image number M+4 is displayed in full screen on the display unit 105. From the state in which images included in the post are aligned and displayed as in FIGS. 7A to 7H, when a tapping operation is performed in which the user touches each image with his or her hand and quickly removes his or her hand, the image is displayed in a wider range on the display unit 105 as illustrated in FIGS. 8C and 8D.

In S506, similarly to as in S307, the CPU 101 determines whether the display angle switching command has been issued through a touch operation or a button operation performed by the user. In a case where it is determined that the display angle switching command has been issued, the process proceeds to S507. Otherwise, the process proceeds to S509.

In S507, the CPU 101 switches the display angle of the active image, for which the switching command has been issued in S506.

In S508, the CPU 101 determines whether the full screen display has been ended. The full screen display ends when a tapping operation is performed on the image again. In a case where it is determined that the full screen display ends, the process proceeds to S512. Otherwise, the process returns to S506.

The processing in S509 to S511 is substantially the same as that in S501 to S503 of FIG. 5. Since the image (the active image) is displayed in full screen in S509 to S511, when the orientation of the smartphone 100 changes on the XY plane by 180° from the state in which display is performed at a display angle of 90° as in FIG. 8C, the display angle reaches 270°.

In S512, the CPU 101 determines whether the active image has been displayed for 360° or more, on the basis of the determination made in S506 or S509 in S505 to S511 that have just been performed. That is, it is determined whether the entire range on the XY plane of the image has been displayed in the state of full screen display. In a case where it is determined that all 360° have been displayed, the process proceeds to S513. Otherwise, the process proceeds to S514. Note that, in step S512, it is sufficient that whether a range has been displayed in almost all the images be determined. Thus, when the active image corresponds to 180°, it is determined whether the active image has been displayed for 180° or more. In addition, a determination may be made not only for all 360° or 180° but also for an arbitrary display angle such as 350° or 160°.

In S513, the CPU 101 updates the display angle αa of the active image to the angle updated in S507 or S511.

In S514, the CPU 101 returns the display angle αa of the active image to the angle used before performance of the full screen display. In a case where the user has viewed the range covering 360° or more, that is, all the range in the full screen display, it is highly likely that a subject desired by the user is present in the display range at the display angle at which display is currently performed. In contrast, in a case where the user has viewed only the range that is smaller than 360°, it is highly likely that the image displayed in full screen is not the one the user wants to view or a portion thereof is only displayed in an enlarged manner, and thus the image is displayed at the previous display angle.

Next, update processing according to the present embodiment will be described using FIG. 6. The update processing is processing for determining whether to change the display angles of other 360° images in a case where the display angle α of the active image is changed in accordance with the orientation of the display unit 105 (the smartphone 100), and is started when the process proceeds to S504 of FIG. 5. Whether to change the display angles of the other 360° images is determined in accordance with whether conditions described later are met.

In S601, the CPU 101 acquires a display angle of and display information on the image having image number 1. In this case, the display information on the image includes whether the image is an active image, information on a time period during which the image has been displayed, tag information, and related-image information. In FIG. 6, in order from image number 1 to N, the update processing is performed on the display angle of each image. A target image subjected to the determination is indicated by image number f.

In S603, the CPU 101 determines whether the image having image number f is the active image. In a case where it is determined that the image is the active image, the process proceeds to S609. Otherwise, the process proceeds to S604.

S604 to S607 illustrate conditions as to whether to change the display angle of each image as the display angle of the active image changes with a change in the orientation of the smartphone 100.

In S604, the CPU 101 determines whether the user operation flag of the image f, which is the target image, is ON. In a case where it is determined that the user operation flag of the image f is ON, the process proceeds to S605. Otherwise, the process proceeds to S606.

In S605, the CPU 101 determines whether a predetermined time period has elapsed after the image f is hidden. The predetermined time period is, for example, a time period of three or ten minutes, and the determination is performed in a period started when the currently displayed post is displayed and is not performed in a period elapsed from when the images of the currently displayed post were displayed last time. In a case where it is determined that the predetermined time has elapsed after the image f is hidden, the process proceeds to S608. Otherwise, the process proceeds to S609.

In S606, the CPU 101 determines whether the image f is a tagged image. In a case where it is determined that the image f is a tagged image on the basis of the display information, the process proceeds to S609. Otherwise, the process proceeds to S607.

In S607, the CPU 101 determines whether the image f is an image related to the active image. In a case where it is determined that the image f is an image related to the active image, the process proceeds to S608. Otherwise, the process proceeds to S609.

In S608, the CPU 101 performs update, so that the display angle αf=αf+γ. That is, the display angle of the image f is changed by a change in the display angle of the active image corresponding to the change in the orientation of the smartphone 100. In this manner, in S608, the display angle of the image for which the user operation flag is ON but at least the predetermined time period has elapsed and the display angle of the image having no tag and related to the active image are changed in synchronization with the change in the display angle of the active image due to the change in the orientation of the smartphone 100.

In S609, the CPU 101 determines whether the determination in S403 has been made for the images having image numbers up to N. That is, it is determined whether all the images included in the post have been determined to be any one of an active image, an inactive image, and an undisplayed image.

In S610, the CPU 101 obtains image number f=f+1. That is, the determination in and after S603 is performed for the next image number.

In S611, the CPU 101 acquires the display state for image number f similarly to as in S601, and the process proceeds to S602 and then to S603.

In this manner, for each of the images having image numbers 1 to N, whether to change the display angle of the image is determined. In S608, the display angles of the images that meet the conditions in the determinations performed in S604 to S607 are changed.

In contrast, the display angle of the image for which the user operation flag is ON and the predetermined time period has not elapsed after the image is hidden, that of the tagged image, and that of the image having no tag and unrelated to the active image are not changed. The fact that the user operation flag of an image is ON means that the user has changed the display angle of the image through, for example, a touch operation. Thus, when the display angle is changed in accordance with a change in the display angle of another image (the active image), the display range the user has been viewing shifts. In a case where the user has caused the display unit 105 to display a desired subject by performing a display range change operation, even in a case where another image is once displayed on the display unit 105 and the orientation of the smartphone 100 is changed, when the image for which the flag is ON is displayed again, it is better if the user can see the desired subject the user was immediately previously looking at. By not changing the display angle as described above, the user can compare a plurality of images including the same subject and see the display range that the user wants to check in each image without searching for it every time switching between display images is performed.

For example, when the images having image numbers M+1 and M+2 are displayed as illustrated in FIG. 7D from the state in which the images having image numbers M and M+1 illustrated in FIG. 7C are displayed, image number M+1 corresponds to the display angle α(M+1)=180° and image number M+2 corresponds to the display angle α(M+2)=90°. Even in a case where the display angle of the image having image number M+1 is changed in FIGS. 7B and 7C, the display angle corresponding to image number M+2 remains the same at α(M+2)=90° from the case of FIG. 7A.

As described above, as illustrated in FIG. 7E, an image having image number M−1 and the image having image number M are individually displayed on the display unit 105 with the display angle α(M−1, M)=0°. In a case where the orientation of the smartphone 100 is rotated clockwise by 90°, the display angle of the active image having image number M is changed. As illustrated in FIG. 7F, in a case where the orientation of the smartphone 100 is rotated clockwise by 90°, the display angle of the image having image number M, which is the active image, is changed and the display angle of the image having image number M−1, which is an inactive image, remains the same at 0°.

In this case, when the images displayed on the display unit 105 are the images having image numbers M and M+1 as illustrated in FIG. 7G, the image having image number M+1 is displayed at the same display angle, the display angle α(M+1)=90°, as in the case of FIG. 7D.

In contrast, in a case where originally the display angle α(M+2)=90° in FIG. 7A, the display angle of the image having image number M+2 is changed. As illustrated in FIG. 7H, when the image having image number M+2 is also displayed on the display unit 105, in a case where the image having image number M is the active image, the display angle α(M+2) is changed by a display angle of 90° due to a change in the orientation of the smartphone 100, and the display angle α(M+2)=180°. Thus, an item 706 illustrated in FIG. 7A corresponds to the display angle α(M+2)=90°; however, an item 707 illustrated in FIG. 7H corresponds to the display angle α(M+2)=180°. In this manner, in a case where the display angle of the active image is changed as the orientation of the smartphone 100 is changed, the display range of the image displayed such that a desired subject is displayed on the display unit 105 by the user performing a touch operation is not changed. Consequently, it is easier for the user to check the desired subject in each image. In addition, regarding related images, in accordance with a change in the display angle of one image as the orientation of the smartphone 100 is changed, the display angle of the other image is also changed. It is thus easy to check the same subject in the two images. The user does not have to perform, every time, a touch operation to change the display angle in order to display the desired subject on the display region of the display unit 105. Note that it has been described that among display images, the display angle of the active image is changed as the orientation of the smartphone 100 is changed; however, in a case where an inactive image and the active image are related images, the display angle of the inactive image may also be changed at the same time.

A related image determination method does not have to be the method that is indicated in S308 of FIG. 3 and in which two images are simultaneously touched. In a case where images of the same subject have been captured at similar angles of view, the images may be treated as related images. In addition, images captured at dates and times the difference between which is within a predetermined time period and images captured at locations the difference between which is within a predetermined distance may also be related images.

According to the embodiment as described above, in a case where the user displays a plurality of images in order, the user can check a desired portion of each image in a user-friendly manner. Even in a case where the display angle of one of the plurality of images is changed as the orientation of the smartphone 100 is changed, in a case where the user has already been adjusted the display angle, the display angle is not changed, and thus the display angle is not unintentionally changed.

After the display angle of a first image is adjusted, another image is displayed once, the orientation of the smartphone 100 is changed, and then the display angle of the other image is changed. When the first image is displayed again, the subject displayed last time can be checked.

Note that the determinations in S605, S606, and S607 described in FIG. 6 do not have to be made, and whether to update the display angle may be determined in accordance with the presence or absence of the user operation flag determined in S604. Any one of the determinations in S604 to S607 may be made or any ones of the determinations may be combined and made.

In addition, in a case where the images having image numbers 1 to N are displayed in order and where an image that has not yet been displayed is displayed in accordance with the display image switching operation in S305 of FIG. 3, the display angle is not updated regardless of the determination made in S604, and the image may be displayed at an initial display angle of 0.

Note that the embodiment above has been described by taking 360° images as an example; however, an image a portion of which is displayed on the display unit 105 and a display portion of which is changed as the orientation of the smartphone 100 is changed such as, for example, a panorama image or a 180° image may also be used. Note that, in the embodiment above, it has been described that the display angle is changed as the orientation of the smartphone 100 is changed on the XY plane; however, the case where the display angle is changed is not limited to this, and the display angle may also be changed as the orientation of the smartphone 100 is changed on the XZ plane.

In addition, the embodiment above has been described by taking a case where a post in an SNS is selected and a plurality of images are displayed as an example; however, this case is not the only case, and the embodiment is also applicable to a case where an image file is selected and a plurality of images in the image file are displayed. Furthermore, it has been described that a plurality of images are aligned in the Y-axis direction on the display unit 105 and when each image is displayed, a portion of the image is displayed on the display unit 105; however, the individual images may be aligned in the X-axis direction and the Y-axis direction. Furthermore, the embodiment may be applicable to a case where not a portion of each image but the entirety of the image is displayed and a portion of each image is displayed in accordance with selection of the image. In that case, the processing described above is performed on the display angle at which display is performed in accordance with selection of the image.

Note that the above-described various types of control performed by the CPU 101 may be performed by a piece of hardware, or the entirety of the device may be controlled by a plurality of pieces of hardware sharing processing.

In addition, the present invention has been described in detail on the basis of its preferred embodiments; however, the present invention is not limited to these specific embodiments, and various embodiments included in the scope that does not depart from the gist of this invention are also included in the present invention. Furthermore, each of the above-described embodiments is a mere embodiment of the present invention, and the individual embodiments may be combined as needed.

In addition, in the embodiments described above, the case where the present invention is applied to a smartphone has been described as an example; however, this is not limited to this example, the present invention may be applicable to any electronic device that can change a display portion of an image. That is, the present invention is applicable to, for example, a portable telephone terminal, a portable image viewer, a printer device with a finder, a digital photo frame, a music player, a game machine, and an electronic book reader.

### OTHER EMBODIMENTS

The present invention can be realized by executing the following processing. That is, the processing is processing in which the software (program) that realizes the functions of the above-described embodiment is supplied to a system or a device via a network or various types of recording medium, and a computer (or a central processing unit (CPU), a microprocessor unit (MPU), or the like) of the system or the device reads out and executes program codes. In this case, the program and the recording medium or mediums storing the program are included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electronic device having a display unit, the electronic device comprising:
a detection means that detects a change in an orientation of the display unit;
a display control means that performs control so as to simultaneously display a region of a portion of a first image and a region of a portion of a second image on the display unit; and
a change means that changes each of the region of the portion of the first image and the region of the portion of the second image displayed on the display unit, wherein
while the detection means is detecting the change in the orientation of the display unit, the change means changes the region of the portion of the first image displayed on the display unit in accordance with the change in the orientation of the display unit,
in a case where the second image meets a predetermined condition, the region of the portion of the second image displayed on the display unit is also changed in accordance with the change in the orientation of the display unit, and
in a case where the second image does not meet the predetermined condition, even in a case where the change in the orientation of the display unit is detected by the detection means, the region of the portion of the second image displayed on the display unit is not changed in accordance with the change in the orientation of the display unit.

2. The electronic device according to claim 1, further comprising:
an operation detection means that detects a predetermined operation performed by a user, wherein
the change means changes, in accordance with the predetermined operation detected by the operation detection means, each of the region of the portion of the first image and the region of the portion of the second image displayed on the display unit, and
the second image does not meet the predetermined condition in a case where, before the change in the orientation of the display unit is detected, the change means has changed the region of the portion of the second image displayed on the display unit in accordance with the predetermined operation detected by the operation detection means.

3. The electronic device according to claim 1, further comprising:
a determination means that determines whether the second image meets the predetermined condition, in accordance with attribute information on the second image.

4. The electronic device according to claim 1, wherein
the second image meets the predetermined condition in a case where at least either the difference between an image capturing date and time of the second image and that of the first image is within a predetermined time period or the difference between an image capturing location of the second image and that of the first image is within a predetermined distance.

5. The electronic device according to claim 1, wherein
the second image does not meet the predetermined condition in a case where information indicating a region of a portion displayed when display is started on the display unit is assigned to the second image.

6. The electronic device according to claim 1, wherein
the second image meets the predetermined condition in a case where a predetermined time period has elapsed after the second image is hidden.

7. The electronic device according to claim 1, further comprising:
an operation detection means that detects a predetermined operation performed by a user, wherein
the second image meets the predetermined condition in a case where the operation detection means simultaneously detects an operation performed on the first image and an operation performed on the second image and a predetermined time period has elapsed after the second image is hidden.

8. The electronic device according to claim 1, further comprising:
an operation detection means that detects a predetermined operation performed by a user, wherein
the second image meets the predetermined condition in a case where the operation detection means simultaneously detects an operation performed on the first image and an operation performed on the second image.

9. The electronic device according to claim 1, wherein
an area of the region of the portion of the first image displayed on the display unit is larger than that of the region of the portion of the second image displayed on the display unit.

10. The electronic device according to claim 1, wherein
a position at which the first image is displayed on the display unit is closer to a predetermined position than a position at which the second image is displayed on the display unit is.

11. The electronic device according to claim 1, further comprising:
a selection means that selects an image displayed on the display unit from among a plurality of images, wherein
the first image is selected by the selection means but the second image is not selected by the selection means.

12. The electronic device according to claim 1, wherein
the first image and the second image are an image having a field of view of 360°, 270°, or 180°.

13. The electronic device according to claim 1, further comprising:
a switching means that switches an image displayed on the display unit by detecting a scroll operation performed on the display unit.

14. The electronic device according to claim 1,
wherein the display control means further performs control, for each image displayed on the display unit, so as to display, on the display unit, an item indicating a region of the image displayed on the display unit.

15. A control method for an electronic device having a display unit, the control method comprising:
a step for detecting a change in an orientation of the display unit;
a step for performing control so as to simultaneously display a region of a portion of a first image and a region of a portion of a second image on the display unit; and
a step for changing each of the region of the portion of the first image and the region of the portion of the second image displayed on the display unit, wherein the steps are executed,
while the change in the orientation of the display unit is being detected, the region of the portion of the first image displayed on the display unit is changed in accordance with the detected change in the orientation of the display unit,
in a case where the second image meets a predetermined condition, the region of the portion of the second image displayed on the display unit is also changed in accordance with the detected change in the orientation of the display unit, and
in a case where the second image does not meet the predetermined condition, even in a case where the change in the orientation of the display unit is detected, the region of the portion of the second image displayed on the display unit is not changed in accordance with the detected change in the orientation of the display unit.

16. A program causing a computer realizing an electronic device having a display unit to execute:
a step for detecting a change in an orientation of the display unit;
a step for performing control so as to simultaneously display a region of a portion of a first image and a region of a portion of a second image on the display unit; and
a step for changing each of the region of the portion of the first image and the region of the portion of the second image displayed on the display unit, wherein
while the change in the orientation of the display unit is being detected, the region of the portion of the first image displayed on the display unit is changed in accordance with the detected change in the orientation of the display unit,
in a case where the second image meets a predetermined condition, the region of the portion of the second image displayed on the display unit is also changed in accordance with the detected change in the orientation of the display unit, and
in a case where the second image does not meet the predetermined condition, even in a case where the change in the orientation of the display unit is detected, the region of the portion of the second image displayed on the display unit is not changed in accordance with the detected change in the orientation of the display unit.

17. A computer readable recording medium storing a program causing a computer realizing an electronic device having a display unit to execute:
a step for detecting a change in an orientation of the display unit;
a step for performing control so as to simultaneously display a region of a portion of a first image and a region of a portion of a second image on the display unit; and
a step for changing each of the region of the portion of the first image and the region of the portion of the second image displayed on the display unit, wherein
while the change in the orientation of the display unit is being detected, the region of the portion of the first image displayed on the display unit is changed in accordance with the detected change in the orientation of the display unit,
in a case where the second image meets a predetermined condition, the region of the portion of the second image displayed on the display unit is also changed in accordance with the detected change in the orientation of the display unit, and
in a case where the second image does not meet the predetermined condition, even in a case where the change in the orientation of the display unit is detected, the region of the portion of the second image displayed on the display unit is not changed in accordance with the detected change in the orientation of the display unit.
